(19) United States
(12) Patent Application Publication
(10) Pub. No.: US 2023/0079275 A1
(43) Pub. Date: Mar. 16, 2023

(54) METHOD AND APPARATUS FOR TRAINING SEMANTIC SEGMENTATION MODEL, AND METHOD AND APPARATUS FOR PERFORMING SEMANTIC SEGMENTATION ON VIDEO

(71) Applicant: Beijing Baidu Netcom Science Technology Co., Ltd., Beijing (CN)

(72) Inventors: Tianyi Wu, Beijing (CN); Yu Zhu, Beijing (CN); Guodong Guo, Beijing (CN)

(21) Appl. No.: 17/985,000

(22) Filed: Nov. 10, 2022

(30) Foreign Application Priority Data
Apr. 13, 2022 (CN) 202210388367.X

(51) Int. Cl. G06V 20/40; G06V 10/26; G06V 10/75; G06V 10/62

(52) U.S. Cl. CPC G06V 20/49; G06V 10/26; G06V 10/751; G06V 20/46; G06V 10/62

(57) ABSTRACT

The present disclosure provides a method and apparatus for training a semantic segmentation model and a method and apparatus for performing a semantic segmentation on a video. The method comprises: acquiring a training sample set, wherein a training sample in the training sample set comprises at least one sample video stream and a pixel-level annotation result of the sample video stream; modeling a spatiotemporal context between video frames in the sample video stream using an initial semantic segmentation model to obtain a context representation of the sample video stream; calculating a temporal contrastive loss based on the context representation of the sample video stream and the pixel-level annotation result of the sample video stream; and updating a parameter of the initial semantic segmentation model based on the temporal contrastive loss to obtain a trained semantic segmentation model.

### CROSS-REFERENCE TO RELATED APPLICATIONS

This application claims priority to Chinese Patent Application No. 202210388367.X, filed with the China National Intellectual Property Administration (CNIPA) on Apr. 13, 2022, the contents of which are incorporated herein by reference in their entirety.

### TECHNICAL FIELD

The present disclosure relates to the field of artificial intelligence technology, specifically to the fields of deep learning and computer vision, and particularly to a method and apparatus for training a semantic segmentation model and a method and apparatus for performing a semantic segmentation on a video.

### BACKGROUND

Semantic segmentation is a fundamental task in the field of computer vision, which aims to predict a semantic tag for each pixel in a given image. With the development of deep learning, great breakthroughs have been made in the image semantic segmentation task. Particularly, the proposal of a fully convolutional network further improves the effect of image semantic segmentation.

### SUMMARY

The present disclosure provides a method and apparatus for training a semantic segmentation model and a method and apparatus for performing a semantic segmentation on a video.

In a first aspect, embodiments of the present disclosure provide a method for training a semantic segmentation model, comprising: acquiring a training sample set, wherein a training sample in the training sample set comprises at least one sample video stream and a pixel-level annotation result of the sample video stream; modeling a spatiotemporal context between video frames in the sample video stream using an initial semantic segmentation model to obtain a context representation of the sample video stream; calculating a temporal contrastive loss based on the context representation of the sample video stream and the pixel-level annotation result of the sample video stream; and updating a parameter of the initial semantic segmentation model based on the temporal contrastive loss to obtain a trained semantic segmentation model.

In a second aspect, embodiments of the present disclosure provide a method for performing a semantic segmentation on a video, comprising: acquiring a target video stream; and inputting the target video stream into a pre-trained semantic segmentation model, to output and obtain a semantic segmentation result of the target video stream, wherein the semantic segmentation model is trained and obtained using the method provided by the first aspect.

In a third aspect, embodiments of the present disclosure provide an apparatus for training a semantic segmentation model, comprising: a first acquiring module, configured to acquire a training sample set, wherein a training sample in the training sample set comprises at least one sample video stream and a pixel-level annotation result of the sample video stream; a modeling module, configured to model a spatiotemporal context between video frames in the sample video stream using an initial semantic segmentation model, to obtain a context representation of the sample video stream; a calculating module, configured to calculate a temporal contrastive loss based on the context representation of the sample video stream and the pixel-level annotation result of the sample video stream; and an updating module, configured to update a parameter of the initial semantic segmentation model based on the temporal contrastive loss to obtain a trained semantic segmentation model.

In a fourth aspect, embodiments of the present disclosure provide an apparatus for performing a semantic segmentation on a video, comprising: a second acquiring module, configured to acquire a target video stream; and an outputting module, configured to input the target video stream into a pre-trained semantic segmentation model, to output and obtain a semantic segmentation result of the target video stream, wherein the semantic segmentation model is trained and obtained using the method provided by the first aspect.

In a fifth aspect, embodiments of the present disclosure provide an electronic device, comprising: one or more processors; and a memory, storing one or more programs, wherein the one or more programs, when executed by the one or more processors, cause the one or more processors to implement the method provided by the first aspect or the second aspect.

In a sixth aspect, embodiments of the present disclosure provide a computer-readable medium, storing a computer program thereon, wherein the program, when executed by a processor, causes the processor to implement the method provided by the first aspect or the second aspect.

In a seventh aspect, an embodiment of the present disclosure provides a computer program product, comprising a computer program, wherein the computer program, when executed by a processor, implements the method provided by the first aspect or the second aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure. Here:

FIG. 1 is a diagram of an exemplary system architecture in which the present disclosure may be applied;

FIG. 2 is a flowchart of an embodiment of a method for training a semantic segmentation model according to the present disclosure;

FIG. 3 is a flowchart of another embodiment of the method for training a semantic segmentation model according to the present disclosure;

FIG. 4 is a schematic diagram of an application scenario of the method for training a semantic segmentation model according to the present disclosure;

FIG. 5 is a flowchart of an embodiment of a method for performing a semantic segmentation on a video according to the present disclosure;

FIG. 6 is a schematic structural diagram of an embodiment of an apparatus for training a semantic segmentation model according to the present disclosure;

FIG. 7 is a schematic structural diagram of an embodiment of an apparatus for performing a semantic segmentation on a video according to the present disclosure; and

FIG. 8 is a block diagram of an electronic device used to implement the method for training a semantic segmentation model and the method for performing a semantic segmentation on a video according to the embodiments of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

It should be noted that the embodiments in the present disclosure and the features in the embodiments may be combined with each other on a non-conflict basis. The present disclosure will be described in detail below with reference to the accompanying drawings and in combination with the embodiments.

FIG. 1 illustrates an exemplary system architecture 100 in which an embodiment of a method for training a semantic segmentation model, a method for performing a semantic segmentation on a video, an apparatus for training a semantic segmentation model, or an apparatus for performing a semantic segmentation on a video according to the present disclosure may be applied.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, for example, wired or wireless communication links, or optical fiber cables.

A user may use the terminal devices 101, 102 and 103 to interact with the server 105 via the network 104 to receive or send information, etc. Various client applications may be installed on the terminal devices 101, 102 and 103.

The terminal devices 101, 102 and 103 may be hardware or software. When being the hardware, the terminal devices 101, 102 and 103 may be various electronic devices, the electronic devices including, but not limited to, a smart phone, a tablet computer, a laptop portable computer, a desktop computer, and the like. When being the software, the terminal devices 101, 102 and 103 may be installed in the listed electronic devices. The terminal devices 101, 102 and 103 may be implemented as a plurality of pieces of software or a plurality of software modules, or as a single piece of software or a single software module, which will not be specifically limited here.

The server 105 may provide various services. For example, the server 105 may analyze and process a training sample set acquired from the terminal devices 101, 102 and 103, and generate a processing result (e.g., a trained semantic segmentation model).

It should be noted that the server 105 may be hardware or software. When being the hardware, the server 105 may be implemented as a distributed server cluster composed of a plurality of servers, or may be implemented as a single server. When being the software, the server 105 may be implemented as a plurality of pieces of software or a plurality of software modules (e.g., software or software modules for providing a distributed service), or may be implemented as a single piece of software or a single software module, which will not be specifically limited here.

It should be noted that the method for training a semantic segmentation model and the method for performing a semantic segmentation on a video that are provided by the embodiments of the present disclosure are generally performed by the server 105, and correspondingly, the apparatus for training a semantic segmentation model and the apparatus for performing a semantic segmentation on a video are generally provided in the server 105.

It should be appreciated that the numbers of the terminal devices, the networks, and the servers in FIG. 1 are merely illustrative. Any number of terminal devices, networks, and servers may be provided based on actual requirements.

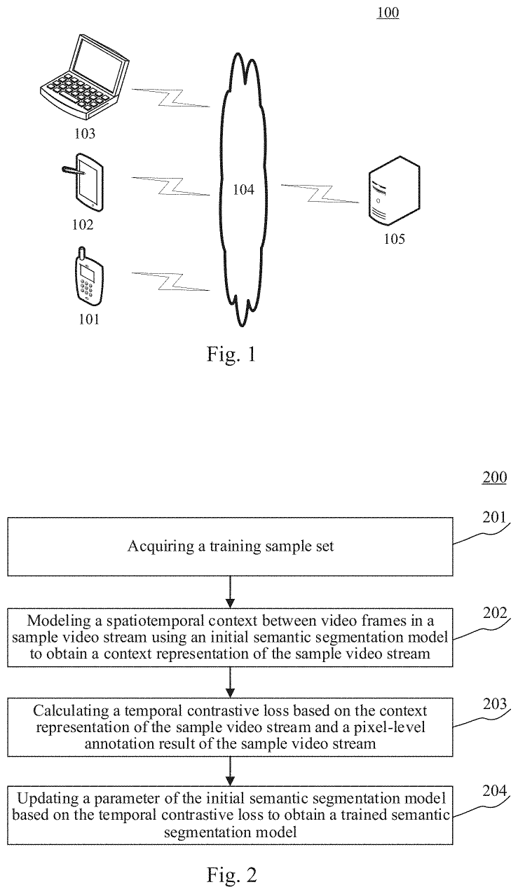

Further referring to FIG. 2, FIG. 2 illustrates a flow 200 of an embodiment of a method for training a semantic segmentation model according to the present disclosure. The method for training a semantic segmentation model includes the following steps:

Step 201, acquiring a training sample set.

In this embodiment, an executing body (e.g., the server 105 shown in FIG. 1) of the method for training a semantic segmentation model may acquire the training sample set. Here, a training sample in the training sample set includes at least one sample video stream and a pixel-level annotation result of the sample video stream.

The sample video stream may be acquired from a collected video, and the training sample set may contain a plurality of sample video streams. The pixel-level annotation result of the sample video stream may be obtained by performing a manual annotation on each frame of image in the sample video stream by a related person, or may be an annotation result obtained based on an existing model, which is not specifically limited in this embodiment. The pixel-level annotation result refers to a pixel-level annotation result of a video frame that is obtained by performing a pixel-level annotation on a video frame image.

Step 202, modeling a spatiotemporal context between video frames in a sample video stream using an initial semantic segmentation model to obtain a context representation of the sample video stream.

In this embodiment, the above executing body may model the spatiotemporal context between the video frames in the sample video stream using the initial semantic segmentation model, thus obtaining the context representation of the sample video stream. Here, the initial semantic segmentation model may be a model pre-trained using an existing data set. Since the training sample in this embodiment refers to a video, and the video is characterized by space and time, the above executing body may model the spatiotemporal context between all the video frames in the sample video stream using the initial semantic segmentation model, thus obtaining the context representation of the sample video stream. The spatiotemporal context refers to a context including information of temporal and spatial dimensions. For example, the above executing body may use the initial semantic segmentation model to respectively extract the features of each video frame in the sample video stream in the temporal and spatial dimensions, and perform modeling based on the features of the each video frame in the temporal and spatial dimensions, thus obtaining the context representation of the sample video stream.

Step 203, calculating a temporal contrastive loss based on the context representation of the sample video stream and a pixel-level annotation result of the sample video stream.

In this embodiment, since the context representation of the sample video stream is obtained based on the initial semantic segmentation model, and the pixel-level annotation result of the sample video stream is obtained by performing an annotation in advance, the above executing body may calculate a difference between the context representation of the sample video stream and the pixel-level annotation result of the sample video stream based on a contrastive loss function, thus obtaining the temporal contrastive loss value of the sample video stream. In order to make the spatiotemporal context satisfy that the context of pixels of different semantic categories has a contrast property and the context of pixels of the same semantic category has a consistency property, the above calculated temporal contrastive loss can dynamically calibrate the context feature of the pixels to the context feature of pixels from an other frame, this context feature having a higher quality.

Step 204, updating a parameter of the initial semantic segmentation model based on the temporal contrastive loss to obtain a trained semantic segmentation model.

In this embodiment, the above executing body may update the parameter of the initial semantic segmentation model based on the calculated temporal contrastive loss, thus obtaining the trained semantic segmentation model. Since the training sample set contains a plurality of sample video streams, the above executing body respectively updates the parameter of the initial semantic segmentation model based on the temporal contrastive loss of each sample video stream, such that the initial semantic segmentation model can be more and more accurate after a plurality of updates on the parameter of the initial semantic segmentation model.

According to the method for training a semantic segmentation model provided in the embodiment of the present disclosure, the training sample set is first acquired. Then, the spatiotemporal context between the video frames in the sample video stream is modeled using the initial semantic segmentation model, to obtain the context representation of the sample video stream. Next, the temporal contrastive loss is calculated based on the context representation of the sample video stream and the pixel-level annotation result of the sample video stream. Finally, the parameter of the initial semantic segmentation model is updated based on the temporal contrastive loss, to obtain the trained semantic segmentation model. According to the method for training a semantic segmentation model in this embodiment, the spatiotemporal context of pixels can be dynamically calibrated to a context obtained from an other frame and having a higher quality, such that the modeled context has both consistency between pixels of the same category and a contrast between pixels of different categories, and the semantic segmentation model has a higher segmentation efficiency and a higher segmentation accuracy.

In the technical solution of the present disclosure, the collection, storage, use, processing, transmission, provision, disclosure, etc. of the personal information of a user all comply with the provisions of the relevant laws and regulations, and do not violate public order and good customs.

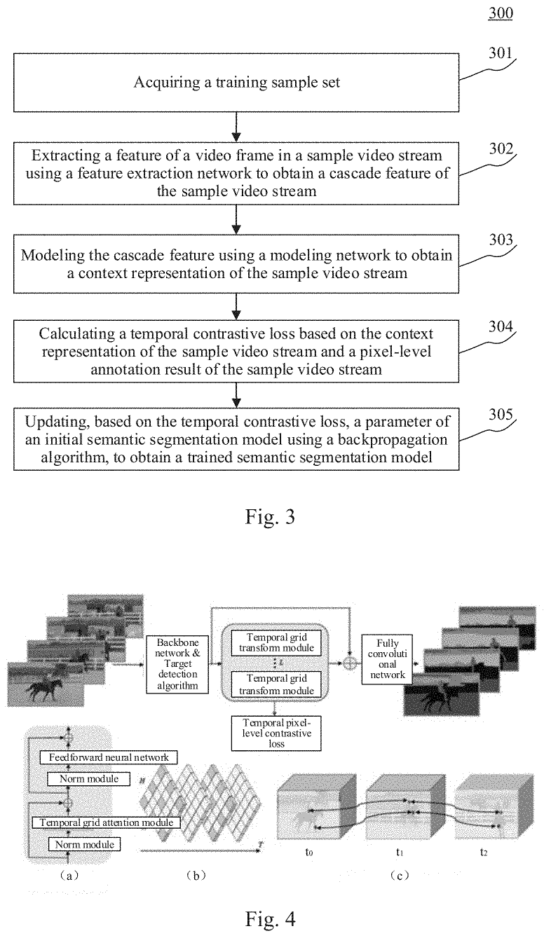

Further referring to FIG. 3, FIG. 3 illustrates a flow 300 of another embodiment of the method for training a semantic segmentation model according to the present disclosure. The method for training a semantic segmentation model includes the following steps:

Step 301, acquiring a training sample set.

In this embodiment, an executing body (e.g., the server 105 shown in FIG. 1) of the method for training a semantic segmentation model acquires the training sample set. Step 301 is substantially consistent with step 201 in the foregoing embodiment. For the specific implementation, reference may be made to the foregoing description for step 201, and thus, the details will not be repeatedly described here.

Step 302, extracting a feature of a video frame in a sample video stream using a feature extraction network to obtain a cascade feature of the sample video stream.

In this embodiment, a semantic segmentation model includes the feature extraction network and a modeling network. Here, the feature extraction network is used to extract a feature of a video frame in a video stream, and the modeling network is used to model a spatiotemporal context of the video stream based on the features of all video frames.

The above executing body uses the feature extraction network of the semantic segmentation model to respectively extract the features of all the video frames in the sample video stream, thereby obtaining the cascade feature of the sample video stream.

In some alternative implementations of this embodiment, step 302 includes: extracting respectively features of all video frames in the sample video stream using the feature extraction network; and cascading the features of all the video frames based on a temporal dimension, to obtain the cascade feature of the sample video stream.

In this implementation, the above executing body first respectively extracts the feature of each video frame in the sample video stream to obtain the features of all the video frames, and cascades the features of all the video frames to obtain the cascade feature of the sample video stream. Therefore, the cascade feature of the sample video stream can be obtained more accurately and quickly.

For example, an input video stream (video clip) is given. First, the feature of each video frame in video clip is extracted using a backbone (the feature extraction network) pre-trained on ImageNet. Then, all the features are cascaded to form a feature F, and F is expressed as F ∈ R^{T×H×W×C}. Here, T is a number of video frames, H and W respectively denote a height and a width, and C is a number of channels of a feature.

Step 303, modeling the cascade feature using a modeling network to obtain a context representation of the sample video stream.

In this embodiment, the above executing body uses the modeling network to model the cascade feature, thereby obtaining the context representation of the sample video stream. That is, the cascade feature of the sample video stream is modeled in temporal and spatial dimensions, thus obtaining the context representation C of the sample video stream, which is expressed as C ∈ R^{T×H×W×C}. Here, T is a number of video frames, H and W respectively denote a height and a width, and C is a number of channels of a feature.

The cascade feature of all the video frames of the sample video stream is first acquired, and then the modeling is performed based on the cascade feature, thus obtaining the spatiotemporal context of the sample video stream. Accordingly, the efficiency and accuracy of obtaining the spatiotemporal context are improved.

In some alternative implementations of this embodiment, step 303 includes: using the modeling network to divide the cascade feature into at least one grid group in the temporal and spatial dimensions; generating a context representation of each grid group based on a self-attention mechanism; and processing the context representation of the each grid group to obtain the context representation corresponding to the sample video stream.

In this implementation, in order to efficiently model a rich spatiotemporal context, the above executing body divides the cascade feature F ∈ [symbol] ^{T×H×W×C} into a plurality of grid groups in the temporal and spatial dimensions, which are respectively {G₁, G₂, . . . , G_{N}}. Here, Gᵢ ∈ [symbol] ^{S}^{ₜ}^{S}^{ₕ}^{S}^{_{w}}^{×C}, i ∈ {1, 2, . . . , N}, where (Sₜ, Sₕ, S_{w}) are respectively the sizes of the grid group in the temporal and spatial (width and height) dimensions. That is, one grid group includes Sₜ×Sₕ×S_{w} features, which can be understood as a uniformly dispersed cube, and accordingly, the number N of grid groups can be expressed as

$$N = \frac{T}{{S}_{t}} ⨯ \frac{H}{{S}_{h}} ⨯ \frac{W}{{S}_{w}} .$$

Then, query, key and value embedding are generated using three linear layers. Subsequently, the context representation of the each grid group is generated based on the self-attention mechanism, that is, self-attention is performed independently in each grid group:

Yᵢ=MSA(ϕ_{Q}(Gᵢ), ϕ_{K}(Gᵢ), ϕ_{V}(Gᵢ)) ∈ [symbol] ^{S}^{ₜ}^{S}^{ₕ}^{S}^{_{w}}^{×C},

Here, MSA( ) denotes multi-head self-attention, and Yᵢ is an update output of an i-th grid group, that is, a context representation of the i-th grid group.

Finally, the above executing body processes the context representation of the each grid group, thus obtaining the context representation corresponding to the sample video stream.

It should be noted that when the feature T×H×W×C is given, and the size of a grid group of the feature is (Sₜ, Sₕ, S_{w}), the computational complexity of using the standard global self-attention is as follows:

Ω_{Global}=2(THW)²C.

The computational complexity of the scheme in this embodiment is as follows:

Ω_{SG-Attention}=2THWSₜSₕS_{w}C.

It can be seen that the computational complexity of the standard global self-attention is the second power of THW, while the computational complexity of the method in this embodiment is the linearity of THW. Therefore, this embodiment reduces the computational complexity.

In some alternative implementations of this embodiment, the processing the context representation of the each grid group to obtain the context representation corresponding to the sample video stream includes: performing a pooling operation on the context representation of the each grid group; and obtaining the context representation corresponding to the sample video stream based on a pooled context representation of the each grid group and a position index of the each grid group.

In this implementation, the executing body first performs pooling processing on the context representation of the each grid group, thereby obtaining the context representation of the each grid group after the pooling operation. Then, according to the original position index of the each grid group, the context representation Y corresponding to the sample video stream is returned, and Y is expressed as Y ∈ [symbol] ^{T×H×W×C}. Here, T is a number of video frames, H and W respectively denote a height and a width, and C is a number of channels of a feature.

Step 304, calculating a temporal contrastive loss based on the context representation of the sample video stream and a pixel-level annotation result of the sample video stream.

In this embodiment, the above executing body calculates the temporal contrastive loss based on the context representation of the sample video stream and the pixel-level annotation result of the sample video stream.

Here, the spatiotemporal context of the sample video stream is expressed as [symbol] ∈ [symbol] ^{T×HW×C}, and the pixel-level annotation result of the sample video stream is expressed as Y ∈ [symbol] ^{T×HW}. Here, T is a number of video frames, H and W respectively denote a height and a width, and C is a number of channels of a feature. Thus, the temporal contrastive loss L_{tpc} is obtained through the following formula:

$${ℒ}_{tpc} = {\sum }_{t} {\sum }_{{t}^{′}} {\sum }_{j} \text{?} - ( {\hat{Y}}_{{t}^{′}}^{{j}^{+}} == {Y}_{t}^{j} ) ( {P}_{{t}^{′}}^{{j}^{+}} > {P}_{t}^{j} ) \cdot log \frac{exp ( {C}_{t}^{j} \cdot {C}_{{t}^{′}}^{{j}^{+}} / τ )}{exp ( {C}_{t}^{j} \cdot {C}_{{t}^{′}}^{{j}^{+}} / τ ) + \text{?} exp ( {C}_{t}^{j} \cdot {C}_{{t}^{′}}^{{j}^{+}} / τ )} , .$$

$$\text{?} \text{indicates text missing or illegible when filed}$$

Here, t denotes a temporal index, j denotes a spatial index, τ>0 is a temperature hyperparameter, [symbol] ⱼ^{t→t′} and [symbol] ⱼ^{t→t′} respectively denote a positive sample set and negative sample set from a frame t′, an anchor pixel j from a video frame t, Yₜ^{j} denote an annotation category of a pixel at a spatial position j of the video frame t, and Ŷ_{t′}^{j+} denotes a predicted category at a spatial position j⁺ of the video frame t′. Moreover, Pₜ^{j} denotes a prediction probability that the pixel at the spatial position j of the video frame t belongs to the annotation category. It should be noted that the positive sample set has the same semantic category as that of the anchor pixel, and the negative sample set has the semantic category different from that of the anchor pixel.

Since the context of pixels of the same semantic category has a consistency property, and the context of pixels of different semantic categories has a contrast property, the difference between the spatiotemporal context of the sample video stream and the pixel-level annotation result of the sample video stream can be calculated and obtained based on the above formula of temporal pixel-level contrastive loss function. Accordingly, the temporal contrastive loss is used to dynamically calibrate the context feature of the pixels to a context feature of pixels from an other frame, this context feature having a higher quality.

Alternatively, the overall loss Lₒᵥₑᵣₐₗₗ may be calculated based on the following formula:

[symbol]

ₒᵥₑᵣₐₗₗ= [symbol] _{seq}+α [symbol] ₐᵤₓ+β [symbol] _{tpc}.

Here, [symbol] _{seq} denotes a semantic segmentation loss (cross entropy) of an annotation, [symbol] ₐᵤₓ denotes an auxiliary segmentation loss, and L_{tpc} denotes a temporal contrastive loss, and α and β are hyperparameters used to balance sub-losses.

Step 305, updating, based on the temporal contrastive loss, a parameter of an initial semantic segmentation model using a backpropagation algorithm, to obtain a trained semantic segmentation model.

In this embodiment, based on the calculated temporal contrastive loss, the above executing body updates the parameter of the initial semantic segmentation model using the backpropagation algorithm, thereby obtaining the trained semantic segmentation model. Alternatively, the above executing body may further update the parameter of the initial semantic segmentation model based on the calculated overall loss Lₒᵥₑᵣₐₗₗ, thereby obtaining the updated semantic segmentation model, such that the obtained semantic segmentation model can perform a semantic segmentation on a video stream more accurately.

It can be seen from FIG. 3 that, as compared with the embodiment corresponding to FIG. 2, the method for training a semantic segmentation model in this embodiment emphasizes the process of obtaining the context representation of the sample video stream by using the initial semantic segmentation model and the process of updating the parameter of the initial semantic segmentation model based on the temporal contrastive loss, thereby further improving the segmentation efficiency and accuracy of the semantic segmentation model obtained through training.

Further referring to FIG. 4, FIG. 4 illustrates a schematic diagram of an application scenario of the method for training a semantic segmentation model according to the present disclosure. In this application scenario, a sample video stream is given. First, the feature of each video frame is respectively extracted using a pre-trained backbone network (which may also be referred to as a feature extraction network) and a target detection algorithm, and the feature of the each video frame is cascaded to form a cascade feature of the sample video stream. Then, a temporal grid transform module (Spatiotemporal Grid Transformer Block, which may also referred to as a modeling network) is used to model a spatiotemporal context between all video frames, to obtain a context representation [symbol] ∈ [symbol] ^{T×H×W×C}. Moreover, a temporal contrastive loss is calculated based on a temporal pixel-level contrastive loss function, and a parameter of an initial semantic segmentation model (modeling network) is updated using the temporal contrastive loss. Finally, a segmentation result is outputted by a fully convolutional network (FCN Head), thereby obtaining a trained semantic segmentation model.

Here, the structure of the temporal grid transform module is as shown in FIG. 4(a), which includes a feedforward neural network (FFN), a norm module, and a spatiotemporal grid attention module (SG-Attention). Here, the SG-Attention is used to model spatiotemporal dependency, the norm module is used to optimize it, and the forward process of a l^{th} block can be formalized as follows:

[symbol]

^{l}= [symbol] ^{l-1}+SG-Attention(LN( [symbol] ^{l-1})),

[symbol]

^{l}= [symbol] ^{l}+FFN(LN( [symbol] ^{l})),

Here, LN( ) denotes a layer normalization, [symbol] ^{l} and [symbol] ^{l-1} are a l^{th} module output and a l−1^{th} module output, FFN( ) denotes a feedforward neural network (including two linear projection layers to expand and contract feature dimensions).

Then, the cascade feature is divided into a plurality of grid groups from dimensions T (time), H (height), and W (width), as shown in FIG. 4(b). One small cube in FIG. 4(b) is one grid group. Then, the spatiotemporal contexts between all the video frames are modeled (from t₀ to t₁ and then to t₂), thereby obtaining the context feature.

Specifically, a rich spatiotemporal context is efficiently modeled by the SG-Attention for all frames in the inputted video clip (video stream), and the SG-Attention divides the inputted feature into a plurality of grid group from the temporal and spatial dimensions. Then, self-attention is performed independently within each grid group. Further, through the temporal pixel-level contrastive loss (TPC loss), the spatiotemporal context of the pixels is dynamically calibrated to a context obtained from an other frame and having a higher quality, such that the learned context has both consistency between pixels of the same category and a contrast between pixels of different categories. Accordingly, the trained semantic segmentation model can segment the video stream to obtain a corresponding segmentation result.

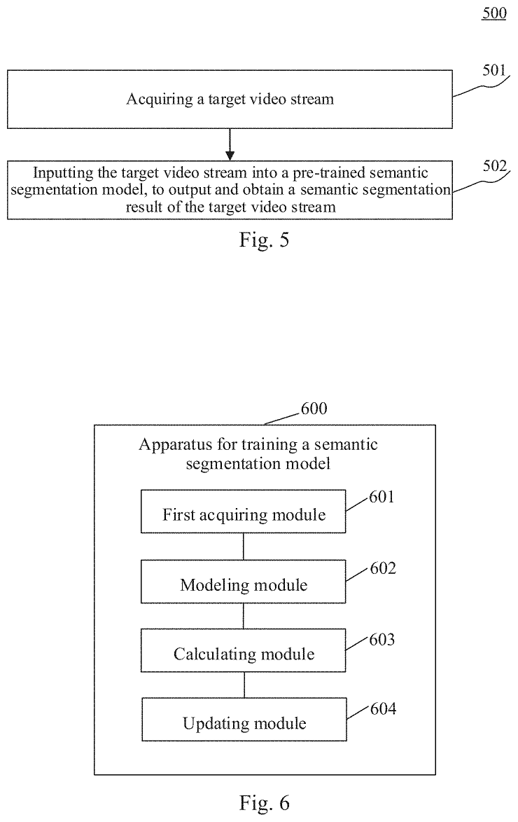

Further referring to FIG. 5, FIG. 5 illustrates a flow 500 of an embodiment of a method for performing a semantic segmentation on a video according to the present disclosure. The method for performing a semantic segmentation on a video includes the following steps:

Step 501, acquiring a target video stream.

In this embodiment, an executing body (e.g., the cloud phone terminal devices 101, 102 and 103 shown in FIG. 1) of the method for performing a semantic segmentation on a video may acquire the target video stream. The target video stream is a video on which a semantic segmentation is to be performed. The target video stream may be any video stream, and may be a video stream including any number of video frames, which is not specifically limited in this embodiment.

Step 502, inputting the target video stream into a pre-trained semantic segmentation model, to output and obtain a semantic segmentation result of the target video stream.

In this embodiment, the above executing body inputs the target video stream into the pre-trained semantic segmentation model, to output and obtain the semantic segmentation result of the target video stream. Here, the semantic segmentation model is trained and obtained using the method described in the foregoing embodiments.

Specifically, after the target video stream is inputted into the semantic segmentation model, the feature extraction network of the semantic segmentation model first extracts the features of all video frames in the target video stream, and cascades the features of all the video frames, thereby obtaining a cascade feature of the target video stream. Then, the modeling network of the semantic segmentation model divides the cascade feature of the target video stream into a plurality of grid groups in the temporal and spatial dimensions, generates the context representation of each grid group based on a self-attention mechanism, and then processes the context representation of the each grid group, thus obtaining the context representation corresponding to the target video stream. Finally, the semantic segmentation result of the target video stream is obtained based on the above context representation, and the semantic segmentation result is outputted.

According to the method for performing a semantic segmentation on a video provided in the embodiment of the present disclosure, the target video stream is first acquired. Then, the target video stream is inputted into the pre-trained semantic segmentation model, to output and obtain the semantic segmentation result of the target video stream. According to the method, the semantic segmentation is performed on the target video stream based on the pre-trained semantic segmentation model, thereby improving the efficiency and accuracy of the semantic segmentation on the target video stream.

Further referring to FIG. 6, as an implementation of the method shown in the above drawings, the present disclosure provides an embodiment of an apparatus for training a semantic segmentation model. The embodiment of the apparatus corresponds to the embodiment of the method shown in FIG. 2, and the apparatus may be applied in various electronic devices.

As shown in FIG. 6, an apparatus 600 for training a semantic segmentation model in this embodiment includes: a first acquiring module 601, a modeling module 602, a calculating module 603 and an updating module 604. Here, the first acquiring module 601 is configured to acquire a training sample set. Here, a training sample in the training sample set comprises at least one sample video stream and a pixel-level annotation result of the sample video stream. The modeling module 602 is configured to model a spatiotemporal context between video frames in the sample video stream using an initial semantic segmentation model, to obtain a context representation of the sample video stream. The calculating module 603 is configured to calculate a temporal contrastive loss based on the context representation of the sample video stream and the pixel-level annotation result of the sample video stream. The updating module 604 is configured to update a parameter of the initial semantic segmentation model based on the temporal contrastive loss to obtain a trained semantic segmentation model.

In this embodiment, for specific processes of the first acquiring module 601, the modeling module 602, the calculating module 603 and the updating module 604 in the apparatus 600 for training a semantic segmentation model, and their technical effects, reference may be respectively made to related descriptions of steps 201-204 in the corresponding embodiment of FIG. 2, and thus, the details will not be repeatedly described here.

In some alternative implementations of this embodiment, the initial semantic segmentation model comprises a feature extraction network and a modeling network. The modeling module comprises: an extracting sub-module, configured to extract a feature of a video frame in the sample video stream using the feature extraction network, to obtain a cascade feature of the sample video stream; and a modeling sub-module, configured to model the cascade feature using the modeling network to obtain the context representation of the sample video stream.

In some alternative implementations of this embodiment, the extracting sub-module comprises: an extracting unit, configured to extract respectively features of all video frames in the sample video stream using the feature extraction network; and a cascading unit, configured to cascade the features of all the video frames based on a temporal dimension, to obtain the cascade feature of the sample video stream.

In some alternative implementations of this embodiment, the modeling sub-module comprises: a dividing unit, configured to use the modeling network to divide the cascade feature into at least one grid group in temporal and spatial dimensions; a generating unit, configured to generate a context representation of each grid group based on a self-attention mechanism; and a processing unit, configured to process the context representation of the each grid group to obtain the context representation corresponding to the sample video stream.

In some alternative implementations of this embodiment, the processing unit comprises: a pooling subunit, configured to perform a pooling operation on the context representation of the each grid group; and an obtaining subunit, configured to obtain the context representation corresponding to the sample video stream based on a pooled context representation of the each grid group and a position index of the each grid group.

In some alternative implementations of this embodiment, the updating module comprises: an updating sub-module, configured to update, based on the temporal contrastive loss, the parameter of the initial semantic segmentation model using a backpropagation algorithm, to obtain the trained semantic segmentation model.

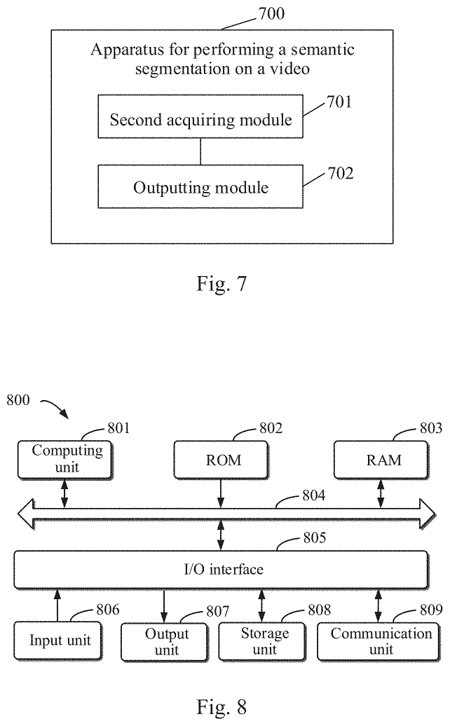

Further referring to FIG. 7, as an implementation of the method shown in the above drawings, the present disclosure provides an embodiment of an apparatus for performing a semantic segmentation on a video. The embodiment of the apparatus corresponds to the embodiment of the method shown in FIG. 5, and the apparatus may be applied in various electronic devices.

As shown in FIG. 7, an apparatus 700 for performing a semantic segmentation on a video in this embodiment includes: a second acquiring module 701 and an outputting module 702. Here, the second acquiring module 701 is configured to acquire a target video stream. The outputting module 702 is configured to input the target video stream into a pre-trained semantic segmentation model, to output and obtain a semantic segmentation result of the target video stream.

In this embodiment, for specific processes of the second acquiring module 701 and the outputting module 702 in the apparatus 700 for performing a semantic segmentation on a video, and their technical effects, reference may be respectively made to related descriptions of steps 501-502 in the corresponding embodiment of FIG. 5, and thus, the details will not be repeatedly described here.

According to an embodiment of the present disclosure, the present disclosure further provides an electronic device, a readable storage medium, and a computer program product.

FIG. 8 is a schematic block diagram of an exemplary electronic device 800 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 8, the device 800 includes a computation unit 801, which may execute various appropriate actions and processes in accordance with a computer program stored in a read-only memory (ROM) 802 or a computer program loaded into a random access memory (RAM) 803 from a storage unit 808. The RAM 803 also stores various programs and data required by operations of the device 800. The computation unit 801, the ROM 802 and the RAM 803 are connected to each other through a bus 804. An input/output (I/O) interface 805 is also connected to the bus 804.

The following components in the device 800 are connected to the I/O interface 805: an input unit 806, for example, a keyboard and a mouse; an output unit 807, for example, various types of displays and a speaker; a storage device 808, for example, a magnetic disk and an optical disk; and a communication unit 809, for example, a network card, a modem, a wireless communication transceiver. The communication unit 809 allows the device 800 to exchange information/data with an other device through a computer network such as the Internet and/or various telecommunication networks.

The computation unit 801 may be various general-purpose and/or special-purpose processing assemblies having processing and computing capabilities. Some examples of the computation unit 801 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computation unit 801 performs the various methods and processes described above, for example, the method for training a semantic segmentation model or the method for performing a semantic segmentation on a video. For example, in some embodiments, the method for training a semantic segmentation model or the method for performing a semantic segmentation on a video may be implemented as a computer software program, which is tangibly included in a machine readable medium, for example, the storage device 808. In some embodiments, part or all of the computer program may be loaded into and/or installed on the device 800 via the ROM 802 and/or the communication unit 809. When the computer program is loaded into the RAM 803 and executed by the computation unit 801, one or more steps of the above method for training a semantic segmentation model or the method for performing a semantic segmentation on a video may be performed. Alternatively, in other embodiments, the computation unit 801 may be configured to perform the method for training a semantic segmentation model or the method for performing a semantic segmentation on a video through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

Cloud computer refers to the elastic and scalable shared physical or virtual resource pool that is accessed through the network. Resources can include servers, operating systems, networks, software, applications, or storage devices, and can be deployed and managed in an on-demand and self-service manner. It can provide efficient and powerful data processing capability for artificial intelligence, blockchain and other technology applications and model training through cloud computing technology.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, a distributed system server, or a server combined with a blockchain.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for training a semantic segmentation model, comprising:
acquiring a training sample set, wherein a training sample in the training sample set comprises at least one sample video stream and a pixel-level annotation result of the sample video stream;
modeling a spatiotemporal context between video frames in the sample video stream using an initial semantic segmentation model to obtain a context representation of the sample video stream;
calculating a temporal contrastive loss based on the context representation of the sample video stream and the pixel-level annotation result of the sample video stream; and
updating a parameter of the initial semantic segmentation model based on the temporal contrastive loss to obtain a trained semantic segmentation model.

2. The method according to claim 1, wherein the initial semantic segmentation model comprises a feature extraction network and a modeling network, and
the modeling a spatiotemporal context between video frames in the sample video stream using an initial semantic segmentation model to obtain a context representation of the sample video stream comprises:
extracting a feature of a video frame in the sample video stream using the feature extraction network to obtain a cascade feature of the sample video stream; and
modeling the cascade feature using the modeling network to obtain the context representation of the sample video stream.

3. The method according to claim 2, wherein the extracting a feature of a video frame in the sample video stream using the feature extraction network to obtain a cascade feature of the sample video stream comprises:
extracting respectively features of all video frames in the sample video stream using the feature extraction network; and
cascading the features of all the video frames based on a temporal dimension, to obtain the cascade feature of the sample video stream.

4. The method according to claim 2, wherein the modeling the cascade feature using the modeling network to obtain the context representation of the sample video stream comprises:
using the modeling network to divide the cascade feature into at least one grid group in temporal and spatial dimensions;
generating a context representation of each grid group based on a self-attention mechanism; and
processing the context representation of the each grid group to obtain the context representation corresponding to the sample video stream.

5. The method according to claim 4, wherein the processing the context representation of the each grid group to obtain the context representation corresponding to the sample video stream comprises:
performing a pooling operation on the context representation of the each grid group; and
obtaining the context representation corresponding to the sample video stream based on a pooled context representation of the each grid group and a position index of the each grid group.

6. The method according to claim 1, wherein the updating a parameter of the initial semantic segmentation model based on the temporal contrastive loss to obtain a trained semantic segmentation model comprises:
updating, based on the temporal contrastive loss, the parameter of the initial semantic segmentation model using a backpropagation algorithm, to obtain the trained semantic segmentation model.

7. A method for performing a semantic segmentation on a video, comprising:
acquiring a target video stream; and
inputting the target video stream into a pre-trained semantic segmentation model, to output and obtain a semantic segmentation result of the target video stream, wherein the semantic segmentation model is trained and obtained using a method for training the semantic segmentation model comprising:
acquiring a training sample set, wherein a training sample in the training sample set comprises at least one sample video stream and a pixel-level annotation result of the sample video stream;
modeling a spatiotemporal context between video frames in the sample video stream using an initial semantic segmentation model to obtain a context representation of the sample video stream;
calculating a temporal contrastive loss based on the context representation of the sample video stream and the pixel-level annotation result of the sample video stream; and
updating a parameter of the initial semantic segmentation model based on the temporal contrastive loss to obtain a trained semantic segmentation model.

8. An electronic device, comprising:
at least one processor; and
a storage device, in communication with the at least one processor,
wherein the storage device stores instructions executable by the at least one processor, and the instructions are executed by the at least one processor, to enable the at least one processor to perform first operations for training a semantic segmentation model, the first operations comprising:
acquiring a training sample set, wherein a training sample in the training sample set comprises at least one sample video stream and a pixel-level annotation result of the sample video stream;
modeling a spatiotemporal context between video frames in the sample video stream using an initial semantic segmentation model to obtain a context representation of the sample video stream;
calculating a temporal contrastive loss based on the context representation of the sample video stream and the pixel-level annotation result of the sample video stream; and
updating a parameter of the initial semantic segmentation model based on the temporal contrastive loss to obtain a trained semantic segmentation model.

9. The electronic device according to claim 8, wherein the initial semantic segmentation model comprises a feature extraction network and a modeling network, and
the modeling a spatiotemporal context between video frames in the sample video stream using an initial semantic segmentation model to obtain a context representation of the sample video stream comprises:
extracting a feature of a video frame in the sample video stream using the feature extraction network to obtain a cascade feature of the sample video stream; and
modeling the cascade feature using the modeling network to obtain the context representation of the sample video stream.

10. The electronic device according to claim 9, wherein the extracting a feature of a video frame in the sample video stream using the feature extraction network to obtain a cascade feature of the sample video stream comprises:
extracting respectively features of all video frames in the sample video stream using the feature extraction network; and
cascading the features of all the video frames based on a temporal dimension, to obtain the cascade feature of the sample video stream.

11. The electronic device according to claim 9, wherein the modeling the cascade feature using the modeling network to obtain the context representation of the sample video stream comprises:
using the modeling network to divide the cascade feature into at least one grid group in temporal and spatial dimensions;
generating a context representation of each grid group based on a self-attention mechanism; and
processing the context representation of the each grid group to obtain the context representation corresponding to the sample video stream.

12. The electronic device according to claim 11, wherein the processing the context representation of the each grid group to obtain the context representation corresponding to the sample video stream comprises:
performing a pooling operation on the context representation of the each grid group; and
obtaining the context representation corresponding to the sample video stream based on a pooled context representation of the each grid group and a position index of the each grid group.

13. The electronic device according to claim 8, wherein the updating a parameter of the initial semantic segmentation model based on the temporal contrastive loss to obtain a trained semantic segmentation model comprises:
updating, based on the temporal contrastive loss, the parameter of the initial semantic segmentation model using a backpropagation algorithm, to obtain the trained semantic segmentation model.
